(19) United States
(12) Patent Application Publication
(10) Pub. No.: US 2006/0170536 A1
(43) Pub. Date: Aug. 3, 2006

(54) Security apparatus for motor vehicles

(76) Inventors: Cheng-Hung Yu, Fengshan City (TW); Cheng-Peng Liu, Kaohsiung City (TW)

Correspondence Address: HOFFMAN, WASSON & GITLER, P.C., Suite 522, 2361 Jefferson Davis Highway, Arlington, VA, 22202, US

(21) Appl. No.: 11/116,467

(22) Filed: Apr. 28, 2005

(30) Foreign Application Priority Data
Jan. 18, 2005 (TW) 94101458

(51) Int. Cl. B60R 25/10; G08B 3/10; G08B 23/00

(52) U.S. Cl. 340/426.1; 340/693.5; 340/384.4

(57) ABSTRACT

A security apparatus for motor vehicles is disclosed, and is featured in integrating all the components into one body as an all-in-one form and in filling resin into the housing of the security apparatus so as to completely cover an electric circuit unit and the interior surface of a siren. The present invention is alternately featured in providing a metal cover covering the externally-exposed surface of the siren for protecting the siren; providing fastening elements each of which has a head hole of special pattern, thereby preventing the security apparatus from being unlawfully dismantled; and providing several detecting modes and power-saving modes, so as to effectively and reliably provide the antitheft function for motor vehicles.

### RELATED APPLICATIONS

The present application is based on, and claims priority from, Taiwan Application Serial Number 94101458, filed Jan. 18, 2005, the disclosure of which is hereby incorporated by reference herein in its entirety.

### FIELD OF THE INVENTION

The present invention relates to a security apparatus for motor vehicles, and more particularly, to the all-in-one and totally waterproof security apparatus for motor vehicles.

### BACKGROUND OF THE INVENTION

Vehicle burglary has been one of the biggest headaches for vehicle owners. While burglars are getting smarter, vehicle owners are getting more and more worried about their motor vehicles being stolen. Therefore, a highly reliable security apparatus for motor vehicles is extremely needed.

Generally speaking, motor vehicles are often exposed to a water-existing environment, and frequently, the electronic devices are out of function on contact with water. Hence, the waterproof issue has become quite important for a security apparatus consisting of high-precision electronic components. A conventional vehicle security apparatus generally envelops its electronic components with potting material, and then is connected externally to a siren and to the vehicle-related components, etc. Since the siren of the conventional vehicle security apparatus is separated from the electronic components (an electronic control module), and the sirens and other components (such as a pager transmitter, etc.) all do not have waterproof designs, so that more than likely those components will lose function on contact with water. In addition, the siren is installed individually, and is exposed to the ambient without any collision-resistant device, and thus is easily to be vandalized by burglars so that the siren loses its function. Further, the components of a conventional vehicle security apparatus are often installed dispersively on a motor vehicle. For example, a pager transmitter, a siren and an electronic control module are separately mounted on the rear end, front end and middle positions of motorcycle's body frame, thus resulting in quite a lot of installation inconvenience for users.

Presently in the market, various types of conventional vehicle security apparatuses mostly focus on vehicle shock detection, and then adjust the sensitivity of shock sensors, thereby providing an antitheft function. However, when a false alarm is caused due to improper sensitivity of shock sensors, or the shock detection method of the motor vehicle is cracked by burglars, the conventional vehicle security apparatuses will lose the antitheft function.

Hence, there is an urgent need to develop a security apparatus for motor vehicles, thereby integrating all the components therein into one body; enabling each component therein to have waterproof protection; providing a collision-resisting device; and providing various types of detection modes for vehicle antitheft, and power-saving modes, thus effectively and reliably providing an antitheft function and a brief installation method for motor vehicles.

### SUMMARY OF THE INVENTION

In accordance with one aspect, the present invention is to provide a security apparatus for motor vehicles for integrating all the components therein into one body, so that the security apparatus can be briefly installed on a motor vehicle.

In accordance with another aspect, the present invention is to a security apparatus for motor vehicles for enabling each component therein to have waterproof protection; providing a collision-resisting device; and providing various types of detection modes for vehicle antitheft, and power-saving modes, thus effectively and reliably providing an antitheft function.

In accordance with another aspect, the present invention is to a security apparatus for motor vehicles for effectively preventing the security apparatus from being unlawfully dismantled by using fastening elements having a head hole with a specific pattern.

According to the aforementioned aspects, a security apparatus for motor vehicles is provided for integrating all the components therein into one body; enabling each component therein to have waterproof protection; providing a collision-resisting device; and providing various types of detection modes for vehicle antitheft, and power-saving modes.

According to an embodiment of the present invention, a security apparatus for motor vehicles comprises a housing, an electric circuit unit, a siren and a resin body, wherein the siren is mounted in an opening located on one end of the housing. The electric circuit unit is arranged in said housing, and the siren is electrically connected to the electric circuit unit. The resin body is filled in the housing for enveloping the electronic circuit unit completely, and covering the interior of the siren.

The security apparatus for motor vehicles further comprises a metal cover covering an externally-exposed surface of the siren, thereby protecting the siren.

The security apparatus for motor vehicles uses a plurality of fastening elements respectively to combine the components of the housing together, wherein each of the fastening elements has a head hole, and the shape of the head hole is a specific pattern having at least one aperture, and each of the fastening elements needs to use a driving tool with a drive head fitting to the specific pattern for fastening.

The security apparatus for motor vehicles further comprises a clipping fixer having a close end and a free end opposite to the close end, wherein a frame structure is formed in the clipping fixer for enclosing and engaging with the recession area of the middle portion.

The electric circuit unit of the present invention comprises a CPU (Central Processing Unit), power-supplying means, voltage-detecting means, spare battery-recharging means, ignition-signal input means, at least one antitheft-signal input means, tilt-signal input means, shock-signal input means, built-in siren driving means, status-monitoring means, indicator-controlling means, starter-immobiliser means, engine-immobiliser means, a memory device, reset means, an X'tal oscillator, power output means, receiving means and power-controlling means.

Hence, with the application of the present invention, each component therein can have the waterproof protection; a siren-resisting device and various types of detection modes for vehicle antitheft can be provided; the security apparatus can be protected from being unlawfully dismantled, thus effectively and reliably providing an antitheft function and a brief installation method for motor vehicles.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic explosive diagram showing a security apparatus for motor vehicles according to an embodiment of the present invention;

FIG. 1B is a schematic diagram showing a semi-assembled security apparatus for motor vehicles according to the embodiment of the present invention; and

FIG. 2 is a schematic block diagram showing an electric circuit unit according to an embodiment of the present invention.

### DETAILED DESCRIPTION OF THE PREFERRED EMBODIMENT

The present invention is featured in integrating all of the components of a security apparatus for motor vehicles in one body, and further filling resin into a housing by a resin-inserting method so as to envelop the electric circuit unit completely, and to cover the interior of a siren. Other features of the present invention are to provide a metal cover covering an externally-exposed surface of the siren, thereby protecting the siren; to provide fastening elements having head holes of specific pattern so as to prevent the security apparatus from being unlawfully dismantled; and provide various types of detection modes for vehicle antitheft and power-saving modes for effectively and reliably providing an antitheft function and a brief installation method for motor vehicles.

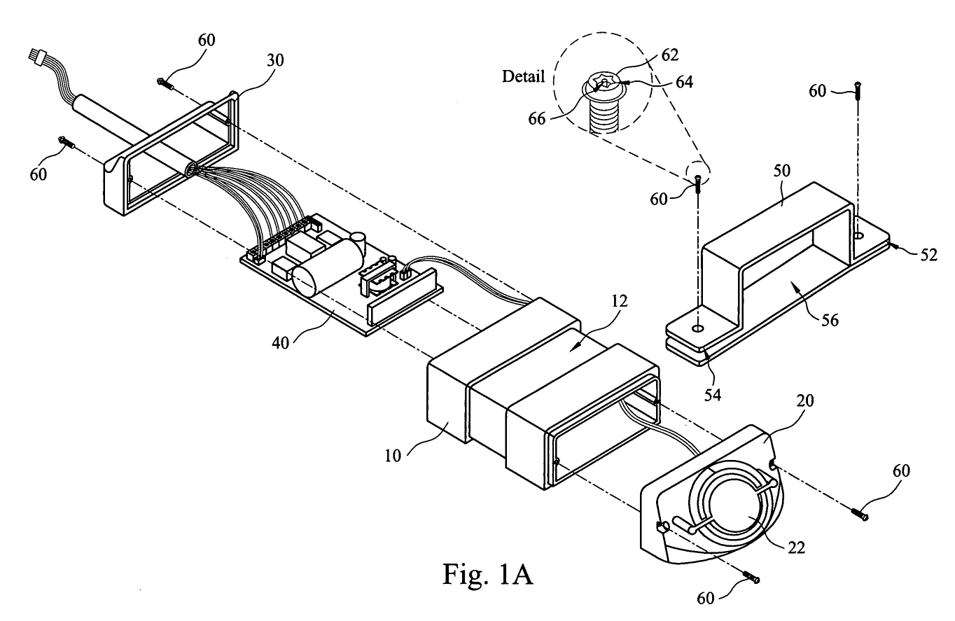

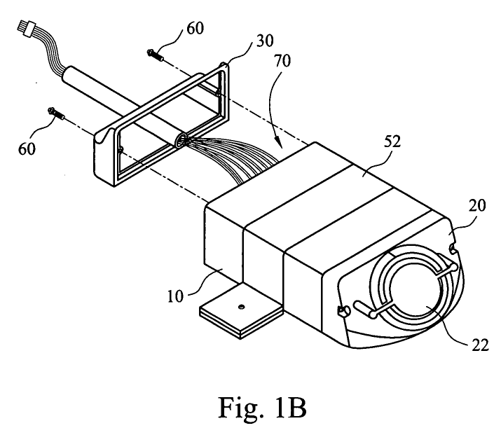

Referring to FIG. 1A and FIG. 1B, FIG. 1A is a schematic explosive diagram showing a security apparatus for motor vehicles according to an embodiment of the present invention, and FIG. 1B is a schematic diagram showing a semi-assembled security apparatus for motor vehicles according to the embodiment of the present invention. The security apparatus of the present invention is installed on a motor vehicle, such as a motorcycle, and is composed of a housing (not labeled), an electric circuit unit 40, a metal cover 22, and a siren (not shown) mounted on the backside of the metal cover 22, a clipping fixer 50 and a resin body (not shown) filled in the housing. The housing is divided into a first end portion 20, a middle portion 10 and a second end portion 30, wherein the first end portion 20 has an opening (not labeled) used for accommodating the siren, and there is a recession area 12 formed along an exterior surface of the middle portion. The siren's surface exposed externally is covered with the metal cover 22 for protecting the siren from being damaged by collision. The metal cover 22 also can provide consonance effect, thereby enhancing the sound effect for the siren. The electric circuit unit 40 is arranged in the middle portion 10 of the housing, and is electrically connected to the siren, a battery of the motor vehicle and other related components. A plurality of fastening elements 60 are used for the housing to fix the first end portion 20 to the middle portion 10, and the middle portion 10 to the second end portion 30 respectively, wherein each of the fastening elements 60 has a head hole 62, the head hole 62 having a specific pattern 64, and the specific pattern 64 can be designed as a common screw head pattern with an aperture 66, so that an ordinary screw drivers can not loosen the fastening elements 60 of the present invention, and a customized driving tool having a special drive head matching the specific pattern 64 has to be used for fastening or releasing the fastening elements 60, thus effectively preventing the security apparatus for motor vehicles from being unlawfully dismantled. The specific pattern shown in detail A of FIG. 1A is merely illustrated as an example for explanation, and the present invention is not limited thereto.

The clipping fixer 50 is used for fixing the housing of the apparatus for motor vehicles to the motor vehicle. The clipping fixer 50 has a close end 52 and a free end 54 opposite to the close end 52, wherein a frame structure 56 is formed therein. While the clipper fixer 50 is being mounted, the free end 54 is first held open so as to enable the frame structure 56 to enclose and engage with the recession area 12 of the middle portion 10. Thereafter, fastening elements 60 are used to lock the close end 52 and the free end 54 on the motor vehicle.

Such as shown in FIG. 1A and FIG. 1B, after the first end portion 20 of the housing is combined with the middle portion 10, an resin-inserting step 70 is performed to fill a resin body (such as epoxy resin) into the first end portion 20 and the middle portion 10 of the housing so as to completely envelop the electric circuit unit 40 and cover the interior of the siren. Then, the second end portion 30 of the housing is fastened to the middle portion 10. Since the first end portion 20 and the middle portion 10 are full of the resin body, and the second end portion 30 merely has an opening through which only conductive wires wrapped with rubber skins are allowed to pass, all the electric components and the siren of the security apparatus can thus have waterproof protection.

Just as described above, the present invention integrates all the components into one housing, and then fills a resin body into the housing via a resin-inserting step, and further covers the externally-exposed surface of the siren with a metal cover, so that the security apparatus of the present invention merely has several connecting lines exposed for users' connection to the related components of the motor vehicle. Hence, the brief structure of the security apparatus of the present invention is quite convenient for users to install without causing confusion.

Moreover, the present invention provides various types of detection modes for vehicle antitheft, and power-saving modes, thus effectively and reliably providing an antitheft function.

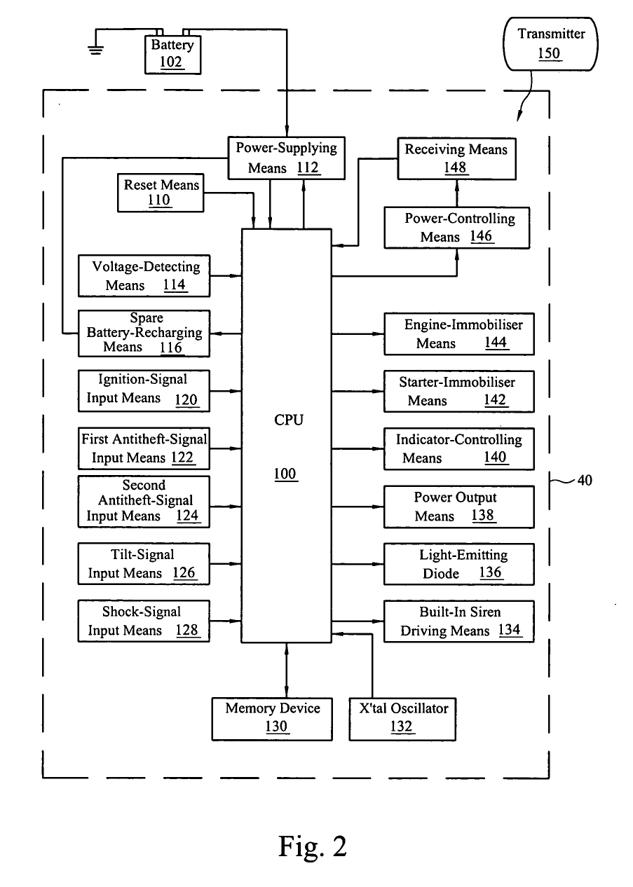

Referring to FIG. 2, FIG. 2 is a schematic block diagram showing an electric circuit unit according to an embodiment of the present invention. The electric circuit unit of the present invention comprises a CPU 100, power-supplying means 112, voltage-detecting means 114, spare battery-recharging means 116, ignition-signal input means 120, first antitheft-signal input means 122, second antitheft-signal input means 124, tilt-signal input means 126, shock-signal input means 128, a memory device 130, an X'tal oscillator 132, built-in siren driving means 134, status-monitoring means 136, power output means 138, indicator-controlling means 140, starter-immobiliser means 142, engine-immobiliser means 144, reset means 110, receiving means 148 and power-controlling means 146 used for the receiving means 148. The CPU 100 is responsible for handling input/output information to/from the other components of the electric circuit unit.

The power-supplying means 112 is connected to a battery 102 of a vehicle for providing power of steady voltage for the security apparatus of the present invention. The voltage-detecting means 114 is used for detecting the voltage change of the battery 102 and if the battery 102 is moved. The spare battery-recharging means 116 is used for providing power for the security apparatus while the security apparatus is in power outage. The ignition-signal input means 120 is used for collecting an ignition signal from the vehicle. The built-in siren driving means 134 is used for driving the siren to issue alarm. The status-monitoring means 136 is used for controlling flashing patterns of a LED (Light-Emitting Diode) that is located outside the security apparatus, thereby indicating the current operation status of the security apparatus. The indicator-controlling means 140 is used for enabling the lamps (such as indicating lights) of the vehicle to flash. The memory device 130 is used for storing the system status of the security apparatus and the configuration data of a transmitter 150 (such as a remote controller), and can be such as EEPROM. The reset means 110 is used for resetting the CPU 100 at a predetermined voltage value, thereby preventing the CPU 100 from working at an abnormal voltage. The X'tal oscillator 132 is responsible for providing fundamental operation frequencies. The power output means 138 is used for providing power source for an externally-attached siren or a pager, wherein the externally-attached siren or the pager is driven to issue alarms by the built-in siren driving means 134. The receiving means 148 is used for receiving signals sent by the transmitter 150, and the signals are then sent to the CPU 100 for executing preset actions after decoding. The power-controlling means 146 is used for controlling power supply to the receiving means 148, thus achieving power-saving purpose.

The present invention provides several types of power-saving modes for the security apparatus. The power-supplying means 112 has a winter mode at which the input current therefrom can be changed to a current value smaller then or equal to a predetermined current value (such as 200 μA), so as to reduce power consumption for preventing the vehicle from having difficulty in winter starting especially after the engine of the vehicle is shutdown for quite a while. Further, the voltage-detecting means 114 can enable the security apparatus to enter a predetermined power-saving mode in accordance with the voltage change of the battery 102. For example, when the voltage of the battery 102 is lowered to a predetermined voltage value, the voltage-detecting means 114 will notify the CPU 100 to shut down the receiving means 148 for power-saving purpose. The aforementioned winter mode also can be set or lifted with the transmitter 150.

The present invention provides several types of detection modes for vehicle antitheft, including antitheft-signal input means activated by triggering (such as the first antitheft-signal input means 122 and the second antitheft-signal input means 124), the tilt-signal input means 126 and the shock-signal input means 128.

The present invention can install at least one antitheft-signal input means on several parts of the vehicle. For example, when the first antitheft-signal input means 122 is applied, a trigger switch is mounted on a prop supporting the vehicle (such as a motorcycle) for standing position. The trigger switch has a first status and a second status (such as a high potential status or a low potential status). When the position of the trigger switch is changed due to the movement of the vehicle, the trigger switch's status will be changed to the low potential status from the high potential status; or to the high potential status from the low potential status. Both statuses provide electrical connection to the CPU 100, and the trigger switch can be triggered or set no matter which status it is in, thereby providing antitheft functions for the CPU 100. When the first antitheft-signal input means 122 is put into practice, the security apparatus (trigger switch) can be set and enter an armed state (which can be at a high potential or a low potential) when the prop of the vehicle touches the ground, for example. When the prop of the vehicle is moved away from the ground, the trigger switch enters the other antitheft status (which can be at a low potential or a high potential), and meanwhile the first antitheft-signal input means 122 will trigger alarm signals via the CPU 100. Further, when the second antitheft-signal input means 124 is applied, the other trigger switch can be installed on the seat of the vehicle (such as a trigger switch installed on a liftable seat of a motorcycle). Similarly, when the second antitheft-signal input means 124 is put into practice, the trigger switch can be set and enter an armed state when the antitheft function is activated, and alarm signals are triggered when the seat is lifted. It is worthy to be noted that the enabling methods of antitheft-signal input means are not limited to the aforementioned ones, i.e. as long as the antitheft-signal input means is set (armed) at one status, alarm signals will be triggered at the other status.

On the other hand, when the vehicle is tilted with a tilt angle, the tilt-signal input means 126 will trigger alarm signals via the CPU 100. When the vehicle is shaken, the shock-signal input means 128 will trigger alarm signals via the CPU 100. Further, when the batter 102 is moved, the voltage-detecting means 114 will trigger alarm signals.

The present invention provides two immobiliser means used for immobilizing the vehicle when alarms signals are triggered, wherein the starter-immobiliser means 142 is used for interrupting the starter motion of the vehicle, and the engine-immobiliser means 144 is used for interrupting the engine motion of the vehicle.

Hence, it can be known from the aforementioned embodiments that the present invention has the following advantages. All the components are integrated into one body, and have waterproof protection. A collision-resisting device, various types of detection modes for vehicle antitheft and power-saving modes are provided, thus effectively and reliably providing an antitheft function and a brief installation method for motor vehicles.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A security apparatus for motor vehicles, comprising:
a housing, wherein one end of said housing has an opening;
an electric circuit unit arranged in said housing;
a siren, wherein said siren is electrically connected to said electric circuit unit, and is mounted in said opening; and
a resin body filled in said housing, wherein said resin body envelops said electric circuit unit, and covers the interior of said siren.

2. The security apparatus of claim 1, further comprising:
a metal cover covering an externally-exposed surface of said siren, thereby protecting said siren.

3. The security apparatus of claim 1, wherein said housing is composed of a first end portion, a middle portion and a second end portion, and a plurality of fastening elements are respectively used to fix said first end portion to said middle portion, and to fix said second end portion to said middle portion, and there is a recession area formed along an exterior surface of said middle portion.

4. The security apparatus of claim 3, wherein each of said fastening elements has a head hole, and the shape of said head hole is a specific pattern having at least one aperture, and each of said fastening elements needs to use a driving tool with a drive head fitting to said specific pattern for fastening.

5. The security apparatus of claim 3, further comprising:
a clipping fixer having a close end and a free end opposite to said close end, wherein a frame structure is formed in said clipping fixer for enclosing and engaging with said recession area of said middle portion.

6. The security apparatus of claim 1, wherein said electric circuit unit comprises:
a CPU (Central Processing Unit) responsible for handling input/output information to/from said electric circuit unit;
power-supplying means for providing power of steady voltage for said security apparatus, wherein said power-supplying means is connected to a battery of a vehicle;
voltage-detecting means for detecting the voltage change of said battery and if said battery is moved, thereby enabling said security apparatus to enter a predetermined power-saving mode in accordance with the voltage change of said battery;
spare battery-recharging means for providing power for said security apparatus while in power outage;
ignition-signal input means for collecting an ignition signal from said vehicle;
at least one antitheft-signal input means, each of said antitheft-signal input means having a trigger switch, said trigger switch having a first status and a second status, wherein said security apparatus is set to an armed state when said trigger switch is in said first status, thereby triggering alarm signals when said trigger switch is in said second status;
tilt-signal input means for triggering alarm signals when said vehicle is tilted;
shock-signal input means for triggering alarm signals when said vehicle is shaken;
built-in siren driving means for driving said siren to issue alarm;
status-monitoring means for controlling flashing patterns of a LED (Light-Emitting Diode), thereby indicating the current operation status of said security apparatus;
indicator-controlling means for enabling the lamps of said vehicle to flash;
starter-immobiliser means for interrupting the starter motion of said vehicle; and
engine-immobiliser means for interrupting the engine motion of said vehicle.

7. The security apparatus of claim 6, wherein said electric circuit unit further comprises:
a memory device used for storing the system status of said security apparatus and the configuration data of a transmitter;
reset means for resetting said CPU at a predetermined voltage value, thereby preventing said CPU from working at an abnormal voltage; and
an X'tal oscillator responsible for providing fundamental operation frequencies.

8. The security apparatus of claim 6, wherein said electric circuit unit further comprises:
power output means for providing power source for an externally-attached siren or a pager, wherein said externally-attached siren or said pager is driven to issue alarms by said built-in siren driving means.

9. The security apparatus of claim 6, wherein said electric circuit unit further comprises:
receiving means for receiving signals sent by a transmitter; and
power-controlling means for controlling power supply to said receiving means.

10. The security apparatus of claim 9, wherein said voltage-detecting means notifies said CPU to shut down said receiving means when the voltage of said battery decreases to a predetermined voltage value, thereby achieving the purpose of saving power.

11. The security apparatus of claim 6, wherein said voltage-detecting means triggers alarm signals when said battery is moved.

12. The security apparatus of claim 6, wherein the input current from said power-supplying means is allowed to be changed to a current value smaller then or equal to a predetermined current value.

13. A security apparatus for motor vehicles, comprising:
a housing composed of a first end portion, a middle portion and a second end portion, said first end portion having an opening, wherein a plurality of fastening elements are respectively used to fix said first end portion to said middle portion, and to fix said second end portion to said middle portion;
a siren, wherein said siren is electrically connected to said electric circuit unit, and is mounted in said opening;
an electric circuit unit arranged in said housing, said electric circuit unit comprising:
a CPU (Central Processing Unit) responsible for handling input/output information to/from said electric circuit unit;
power-supplying means for providing power of steady voltage for said security apparatus, wherein said power-supplying means is connected to a battery of a vehicle;
voltage-detecting means for detecting the voltage change of said battery and if said battery is moved, thereby enabling said security apparatus to enter a predetermined power-saving mode in accordance with the voltage change of said battery, and said voltage-detecting means triggers alarm signals when said battery is moved;
spare battery-recharging means for providing power for said security apparatus while in power outage;
ignition-signal input means for collecting an ignition signal from said vehicle;
at least one antitheft-signal input means, each of said antitheft-signal input means having a trigger switch, said trigger switch having a first status and a second status, wherein said security apparatus is set to an armed state when said trigger switch is in said first status, thereby triggering alarm signals when said trigger switch is in said second status;
tilt-signal input means for triggering alarm signals when said vehicle is tilted;
shock-signal input means for triggering alarm signals when said vehicle is shaken;
built-in siren driving means for driving said siren to issue alarm;
status-monitoring means for controlling flashing patterns of a LED (Light-Emitting Diode), thereby indicating the current operation status of said security apparatus;
indicator-controlling means for enabling the lamps of said vehicle to flash;
starter-immobiliser means for interrupting the starter motion of said vehicle; and
engine-immobiliser means for interrupting the engine motion of said vehicle;
a resin body filled in said housing, wherein said resin body envelops said electric circuit unit, and covers the interior of said siren; and
a metal cover covering an externally-exposed surface of said siren, thereby protecting said siren.

14. The security apparatus of claim 13, wherein each of said fastening elements has a head hole, and the shape of said head hole is a specific pattern having at least one aperture, and each of said fastening elements needs to use a driving tool with a drive head fitting to said specific pattern for fastening.

15. The security apparatus of claim 13, further comprising:
a clipping fixer having a close end and a free end opposite to said close end, wherein a frame structure is formed in said clipping fixer for enclosing and engaging with a recession area formed along an exterior surface of said middle portion,

16. The security apparatus of claim 13, wherein said electric circuit unit further comprises:
a memory device used for storing the system status of said security apparatus and the configuration data of a transmitter;
reset means for resetting said CPU at a predetermined voltage value, thereby preventing said CPU from working at an abnormal voltage; and
an X'tal oscillator responsible for providing fundamental operation frequencies.

17. The security apparatus of claim 13, wherein said electric circuit unit further comprises:
power output means for providing power source for an externally-attached siren or a pager, wherein said externally-attached siren or said pager is driven to issue alarms by said built-in siren driving means.

18. The security apparatus of claim 13, wherein said electric circuit unit further comprises:
receiving means for receiving signals sent by a transmitter; and
power-controlling means for controlling power supply to said receiving means.

19. The security apparatus of claim 18, wherein said voltage-detecting means notifies said CPU to shut down said receiving means when the voltage of said battery decreases to a predetermined voltage value, thereby achieving the purpose of saving power.

20. The security apparatus of claim 13, wherein the input current from said power-supplying means is allowed to be changed to a current value smaller then or equal to a predetermined current value.
